(19) United States
(12) Patent Application Publication
(10) Pub. No.: US 2019/0111915 A1
(43) Pub. Date: Apr. 18, 2019

(54) Method for Increasing the Safety of a Hybrid Vehicle

(71) Applicant: Schaeffler Technologies AG & Co. KG, Herzogenaurach (DE)

(72) Inventor: Michael Reuschel, Ottersweier (DE)

(73) Assignee: Schaeffler Technologies AG & Co. KG, Herzogenaurach (DE)

(21) Appl. No.: 16/090,603

(22) PCT Filed: Mar. 17, 2017
(86) PCT No.: PCT/DE2017/100211

§ 371 Date: Oct. 2, 2018

(30) Foreign Application Priority Data
Apr. 6, 2016 (DE) 10 2016 205 650.6

(51) Int. Cl. B60W 20/50; B60K 6/48; B60W 10/06; B60W 10/113; B60W 20/40

(52) U.S. Cl. CPC B60W 20/50; B60K 6/48; B60W 10/06; B60W 2710/244; B60W 20/40; B60W 2710/0644; B60W 2710/081; B60W 10/113

(57) ABSTRACT

A method for increasing a safety of a hybrid vehicle is disclosed. The hybrid vehicle includes a hybrid separating clutch configured to disconnect or connect an internal combustion engine and an electric motor. A torque output by the internal combustion engine and/or the electric motor is transferred to drive wheels of the hybrid vehicle. When using the electric motor as a drive motor, in an event of a fault in the hybrid separating clutch, a revolution rate (NIce) of the internal combustion engine is limited to a current revolution rate (NEMot) of the electric motor.

### CROSS-REFERENCE TO RELATED APPLICATIONS

This application is the U.S. National Phase of PCT Appln. No. PCT/DE2017/100211 filed Mar. 17, 2017, which claims priority to 10 2016 205 650.6 filed Apr. 6, 2016, the entire disclosures of which are incorporated by reference herein.

### TECHNICAL FIELD

The present disclosure concerns a method for increasing the safety of a hybrid vehicle, in which a hybrid separating clutch disconnects or connects an internal combustion engine and an electric motor and the torque output by the internal combustion engine and/or the electric motor is transferred to the drive wheels of the hybrid vehicle.

### BACKGROUND

In hybrid vehicles that allow different combinations of the types of drives, such as electric motor, electrical generator, internal combustion engine in overrun mode or acceleration mode, internal combustion engine or electric motor OFF, mechanical decoupling of the torques from the internal combustion engine and electric motor is necessary. The decoupling of the internal combustion engine and the electric motor is typically carried out in this case by a hybrid separating clutch that is operated automatically. Said automatic operation of the hybrid separating clutch is carried out by means of an actuator, consisting of a control unit with suitable software for actuating the electromechanical or electrohydraulic actuator that operates the clutch. However, in predetermined operating states in which the hybrid separating clutch must be disengaged, it can occur that the hybrid separating clutch engages as a result of faulty actuation by the control unit, which can result in safety problems when driving the hybrid vehicle. Measures that are known to increase the safety of the hybrid vehicle in the event of a fault of this type consist of a further clutch, which is typically disposed in a downstream gearbox, changing to a protection mode by fully or partially disengaging the downstream clutch.

### SUMMARY

It is the object of the present disclosure to specify a method for increasing the safety of a hybrid vehicle that is used to prevent safety risks in the event of incorrect disengagement of the hybrid separating clutch.

According to the present disclosure, the object is achieved by limiting a revolution rate of the internal combustion engine to the current revolution rate of the electric motor in the event of a fault of the hybrid separating clutch when using the electric motor as the drive motor. As a result of the revolution rate of the internal combustion engine not exceeding the revolution rate of the electric motor, acceleration of the hybrid vehicle cannot be carried out, so that safety-critical situations that can be caused by unintentional acceleration of the hybrid vehicle are reliably prevented.

Advantageously, the revolution rate of the internal combustion engine is adjusted to be less than or equal to the current revolution rate of the electric motor if the revolution rate of the electric motor equals or exceeds an idling revolution rate of the internal combustion engine.

This has the advantage that the internal combustion engine does continue working and for example can be used to charge a high voltage battery of the electric motor, but it can make no contribution to driving the hybrid vehicle.

In an alternative, ignition of the internal combustion engine is suppressed if the current revolution rate of the electric motor lies below the idling revolution rate of the internal combustion engine. It is thereby ensured that the internal combustion engine is not activated and hence makes no contribution to driving the hybrid vehicle.

In one version, if there is no limit on the revolution rate of the internal combustion engine to the current revolution rate of the electric motor when it exceeds the electric motor revolution rate, a torque intervention on the internal combustion engine is carried out. By means of such a torque intervention, the revolution rate of the internal combustion engine can be reduced and hence the effect thereof on the drive of the hybrid vehicle can be limited.

Alternatively, if there is no limit on the revolution rate of the internal combustion engine to the current revolution rate of the electric motor when it exceeds the revolution rate of the electric motor, an ignition intervention is carried out on the internal combustion engine. By suppressing internal combustion engine ignitions, an increase in the revolution rate of the internal combustion engine can be prevented.

In one embodiment, for monitoring the fault behavior of the hybrid separating clutch the revolution rates of the internal combustion engine and the electric motor are monitored. Because of this, it can be reliably concluded whether the hybrid separating clutch is transmitting a coupling torque or not, i.e. whether the clutch is engaged or disengaged.

Advantageously, for monitoring the fault behavior of the hybrid separating clutch, a modulation signal is superimposed on the revolution rate of the electric motor, whereby when the modulation signal on the revolution rate of the internal combustion engine occurs it is concluded that the hybrid separating clutch is transmitting a torque. Said monitoring method is particularly advantageous if the hybrid separating clutch should actually be disengaged. On detecting transmission of the modulation signal on the revolution rate of the internal combustion engine, it can be reliably concluded that the hybrid separating clutch is in an unintentionally engaged state.

A development of the present disclosure concerns a method for increasing the safety of a hybrid vehicle, in which a hybrid separating clutch disconnects or connects an internal combustion engine and an electric motor and the torque output by the internal combustion engine and/or the electric motor is transferred to drive wheels of the hybrid vehicle. In the case of a method with which the safety state of the hybrid vehicle can be increased, when driving away with an electric motor the hybrid separating clutch is disengaged, whereby as a result of a low battery state of a battery of the electric motor, the internal combustion engine is started to charge the battery, whereby in the event of unintentional engagement of the hybrid separating clutch a method according to a feature in this intellectual property application is initiated.

### BRIEF DESCRIPTION OF THE DRAWINGS

The present disclosure permits numerous exemplary embodiments. One of these will be explained in detail using the figures represented in the drawing.

In the figures:

FIG. 1 shows a schematic representation of a hybrid drive,

FIG. 2 shows an exemplary embodiment for a situation of the driving mode of the hybrid vehicle according to the prior art,

FIG. 3 shows an exemplary embodiment of the method according to the present disclosure.

### DETAILED DESCRIPTION

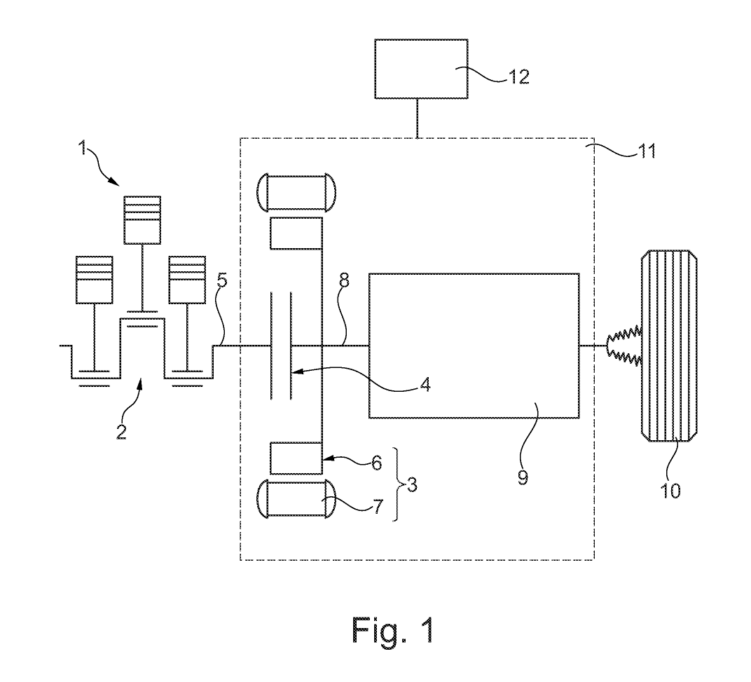

In FIG. 1 a schematic representation of a drive train 1 of a hybrid vehicle is represented. Said drive train 1 comprises an internal combustion engine 2 and an electric motor 3. Between the internal combustion engine 2 and the electric motor 3, a hybrid separating clutch 4 is disposed immediately after the internal combustion engine 2. The internal combustion engine 2 and the hybrid separating clutch 4 are connected to each other by means of a crankshaft 5. The electric motor 3 comprises a rotatable rotor 6 and a fixed stator 7. The drive shaft 8 of the hybrid separating clutch 4 is connected to a gearbox 9 containing a coupling element that is not further represented, for example a second clutch or a torque converter disposed between the electric motor 3 and the gearbox 9. The gearbox 9 transmits the torque produced by the internal combustion engine 2 and/or the electric motor 3 to the drive wheels 10 of the hybrid vehicle. In this case, the electric motor 3 and the gearbox 9 form a transmission system 11 that is actuated by a hydrostatic clutch actuator 12.

The hybrid separating clutch 4 disposed between the internal combustion engine 2 and the electric motor 3 is engaged to start the internal combustion engine 2 while the hybrid vehicle 1 is traveling with the torque produced by the electric motor 3 or to drive during a boost mode with the internal combustion engine 2 and the electric motor 3 being driven. During this, the hybrid separating clutch 4 is operated by the hydrostatic clutch actuator 12.

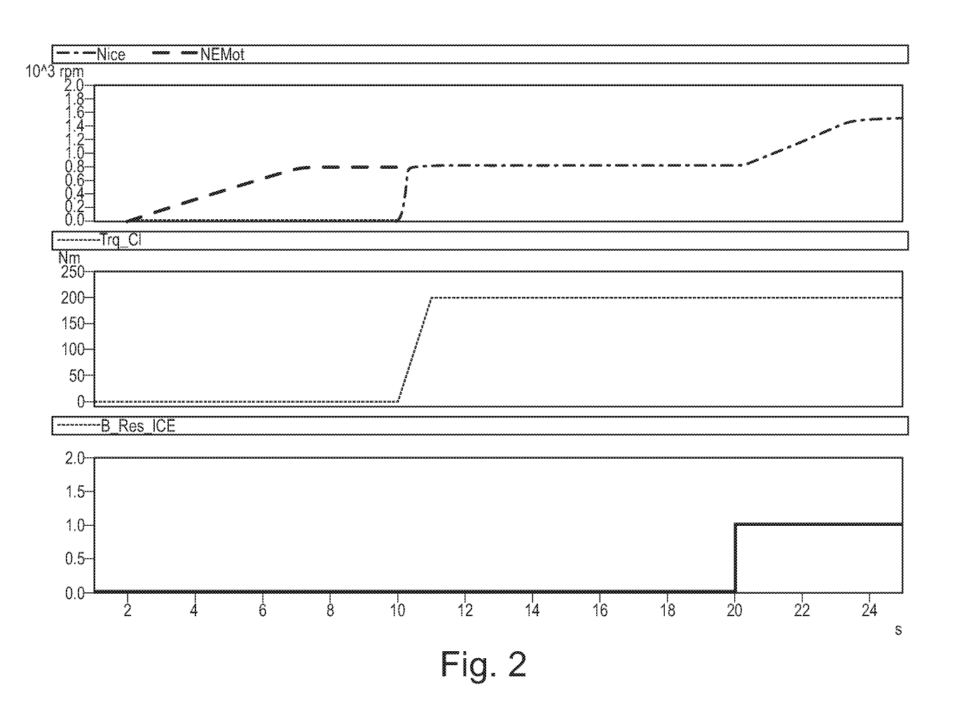

In a further operating state, the hybrid vehicle is driven away from a standstill by the electric motor 3. The internal combustion engine 2 is stationary, whereby the hybrid separating clutch 4 is disengaged. In FIG. 2a, the revolution rate NIce of the internal combustion engine 2 and the revolution rate NEMot the electric motor 3 are shown against time. FIG. 2b shows the current torque Trq_Cl transmitted by the hybrid separating clutch 4, whereas in FIG. 2c the request B_Res_Ice to start the internal combustion engine 2 is shown. As can be seen from FIG. 2, the hybrid separating clutch is unintentionally engaged 4 at time t=10s, caused by a defect in the hydrostatic clutch actuator 12, and a torque Trq_Cl is being transmitted. At time t=20s, however, the internal combustion engine 2 is started owing to a low battery state of charge (SOC) of a high voltage battery, which is not shown further, of the electric motor 3, which is intended to charge the battery by an increased charging revolution rate NIce of approx. 1500 rpm. However, for said state it is necessary that the hybrid separating clutch 4 is disengaged. Because the hydrostatic clutch actuator 12 of the hybrid separating clutch 4 is engaged owing to the defect, the hybrid vehicle is unintentionally accelerated from a time t>20s, which can result in a critical driving situation.

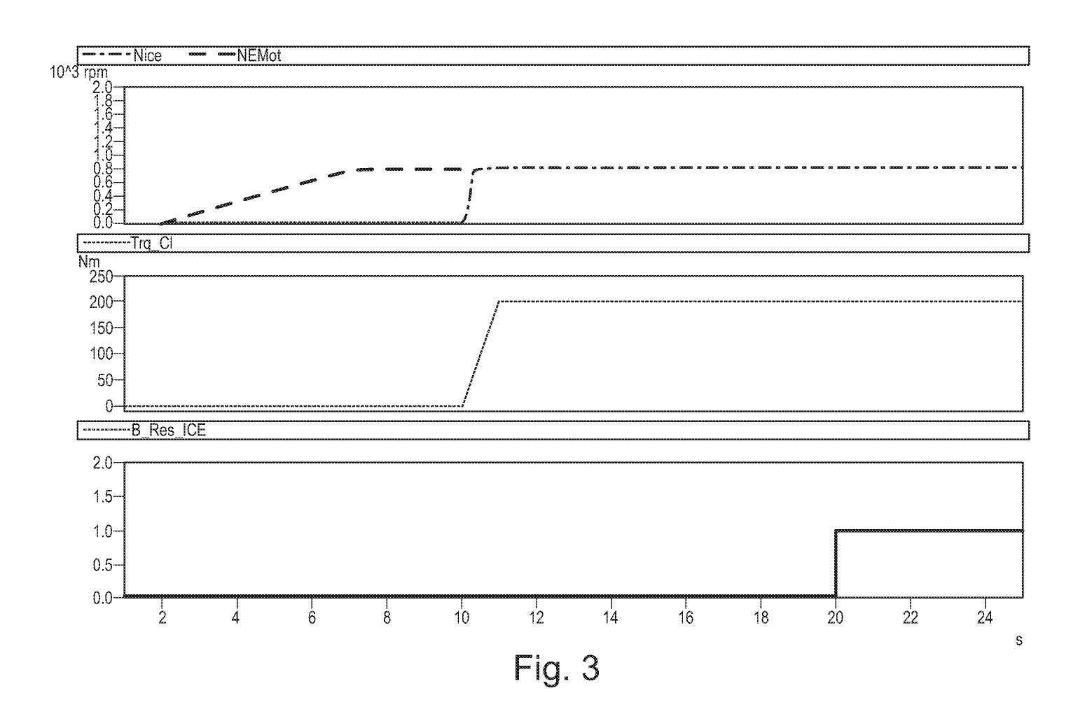

The hazard situation described in connection with FIG. 2 can be prevented by using the method according to the present disclosure, as is shown in FIG. 3 using an exemplary embodiment. FIG. 3 comprises the same sub diagrams 3a, 3b, 3c as FIG. 2. In the case in which the hybrid separating clutch 4 is unintentionally engaged at time t=10s, the engagement of said hybrid separating clutch 4 is detected. The detection is carried out during this by the monitoring of the revolution rates of the internal combustion engine 2 and the electric motor 3. In order to determine whether the hybrid separating clutch 4 is effectively transmitting a torque, a modulation signal that is not relevant to ride comfort is superimposed on the revolution rate of the electric motor 3. Said modulation signal can be for example a 30 Hz sinusoidal oscillation with a small torque magnitude. If the hybrid separating clutch 4 is engaged as in the present case, then said modulation occurs on the revolution rate signal of the internal combustion engine 2. This can be checked by a correlation method or a log-in method. Using said analysis, it is reliably determined that the clutch is not disengaged.

However, because it is known that the hybrid separating clutch 4 is not disengaged, a revolution rate mode is set up on the internal combustion engine 2 that limits the revolution rate NIce of the internal combustion engine 2 to the current revolution rate NEMot of the electric motor 3. In the specified case, the revolution rate NIce of the internal combustion engine 2 may have a maximum magnitude of 800 rpm. This means that at time t=20s, if the request to charge the battery of the electric motor 3 occurs, no higher revolution rate NIce can be set on the internal combustion engine 2. Thus, unintentional accelerations of the hybrid vehicle by the internal combustion engine 2 are prevented despite the hybrid separating clutch 4 being engaged.

Owing to the method described, in cases in which the electric motor 3 is acting as the drive motor, the revolution rate NIce of the internal combustion engine 2 is not greater than the revolution rate NEMot of the electric motor 3.

### REFERENCE CHARACTER LIST

1 drive train
2 internal combustion engine
3 electric motor
4 hybrid separating clutch
5 crankshaft
6 rotor
7 stator
8 drive shaft
9 gearbox
10 drive wheels
11 transmission system
12 hydrostatic clutch actuator
NIce revolution rate of the internal combustion engine
NEMot revolution rate of the electric motor
Trq-Cl torque of the hybrid separating clutch

1. A method for increasing a safety of a hybrid vehicle, wherein the hybrid vehicle includes a hybrid separating clutch configured to disconnect or connect an internal combustion engine and an electric motor and a torque output by the internal combustion engine and/or the electric motor is transferred to drive wheels of the hybrid vehicle, the method comprising:
when using the electric motor as a drive motor, in an event of a fault in the hybrid separating clutch, limiting a revolution rate (NIce) of the internal combustion engine a current revolution rate (NEMot) of the electric motor.

2. The method as claimed in claim 1, wherein the revolution rate (NIce) of the internal combustion engine is set to be less than or equal to the current revolution rate (NEMot) of the electric motor if the revolution rate (NEMot) of the electric motor is greater than or equal to an idling revolution rate of the internal combustion engine.

3. The method as claimed in claim 1, wherein ignition of the internal combustion engine is inhibited if the current revolution rate (NEMot) of the electric motor, is less than an idling revolution rate of the internal combustion engine.

4. The method as claimed in claim 1, wherein in an absence of a limit on the revolution rate (NIce) of the internal combustion engine to the current revolution rate (NEMot) of the electric motor when it exceeds the revolution rate of the electric motor (NEMot), a torque intervention is carried out on the internal combustion engine.

5. The method as claimed in claim 1, wherein in an absence of a limit on the revolution rate (NIce) of the internal combustion engine to the current revolution rate (NEMot) of the electric motor when it exceeds the revolution rate of the electric motor (NEMot), an ignition intervention is carried out on the internal combustion engine.

6. The method as claimed in claim 1, further comprising:
monitoring a fault behavior of the hybrid separating clutch, wherein the revolution rates of the internal combustion engine and the electric motor are monitored.

7. The method as claimed in claim 6, wherein for monitoring the fault behavior of the hybrid separating clutch, a modulation signal is superimposed on the revolution rate (NEMot) of the electric motor, whereby when the modulation signal occurs on the revolution rate (NIce) of the internal combustion engine it is determined that the hybrid separating clutch is transmitting a torque (Trq-Cl).

8. (canceled)

9. A hybrid vehicle, comprising:
a hybrid separating clutch configured to selectively disconnect or connect an internal combustion engine and an electric motor, wherein a revolution rate (NIce) of the internal combustion engine is limited to a current revolution rate (NEMot) of the electric motor in response to a fault in the hybrid separating clutch when using the electric motor as a drive motor.

10. The hybrid vehicle of claim 9, wherein, in response to the revolution rate of the electric motor equaling or exceeding an idling revolution rate of the internal combustion engine, the revolution rate of the internal combustion engine is adjusted to be less than or equal to the current revolution rate of the electric motor.

11. The hybrid vehicle of claim 9, wherein, in response to the current revolution rate of the electric motor being below an idling revolution rate of the internal combustion engine, ignition of the internal combustion engine is suppressed.
